(19) United States
(12) Patent Application Publication
(10) Pub. No.: US 2008/0277898 A1
(43) Pub. Date: Nov. 13, 2008

(54) Reinforced motorcycle frame

(76) Inventors: Julia Chu, Christchurch (NZ); Michael David Hodgkinson, Christchurch (NZ)

Correspondence Address: Hershkovitz & Associates, LLC, 2845 Duke Street, Alexandria, VA, 22314, US

(21) Appl. No.: 11/798,136

(22) Filed: May 10, 2007

(51) Int. Cl. B62K 11/02; B62D 21/02

(52) U.S. Cl. 280/281.1; 180/311; 280/796

(57) ABSTRACT

A reinforced motorcycle frame that is structurally strong and has a light and compact structure. The reinforced motorcycle frame has a head tube, at least two main beams, multiple transverse rods, at least one support beam, at least two mounting struts and at least two reinforcing struts. The main beams and at least one support beams are connected to and extend down from the head tube. The transverse rods are mounted between and strengthen the main beams. The mounting struts connect the at least one support beam to the main beams. The reinforcing struts connect the at least one support beam to the main beams to further strengthen the reinforced motorcycle frame.

### BACKGROUND OF THE INVENTION

1. Field of the Invention

The present invention relates to a frame, and more particularly to a reinforced motorcycle frame that is structurally strong and has a light and compact structure.

2. Description of Related Art

A motorcycle comprises a frame made of steel, iron, aluminum, titanium or carbon fiber to form a body of the motorcycle and keep components of the motorcycle from being struck.

Generally, a conventional motorcycle frame includes at least one main beam and at least one support beam. The main beam has an adequate strength for the motorcycle and may be curved or bent. The support beam usually protrudes from the main beam, provides supplemental support for the main beam and defines a space between the main beam and the support beam in which an engine, a carburetor and the like of the motorcycle can be mounted.

However, some motorcycles like dirt bikes must have very strong frames, and the conventional motorcycle frame used with these motorcycles tends to have large main beams and thick support beams. Consequently, such frames are heavy, bulky and large and may cause the motorcycle to waste fuel.

To overcome the shortcomings, the present invention provides a reinforced motorcycle frame to obviate or mitigate the aforementioned problems.

### SUMMARY OF THE INVENTION

The main objective of the present invention is to provide a reinforced motorcycle frame that is structurally strong and has a light and compact structure.

To achieve the objective, the reinforced motorcycle frame in accordance with present invention comprises at least two main beams, at least one support beam and multiple reinforcing struts.

The main beams have adequate strength and may be curved or bent.

The support beam protrudes from the main beam, provides supplemental support for the main beam and defines a space between the main beams and the at least one support beam in which an engine, a carburetor or the like of a motorcycle can be mounted.

The reinforcing struts are mounted between the main beams and the main beams and the support beam to enhance overall structural strength of the reinforced motorcycle frame.

The reinforcing struts make large main beams and large support beams unnecessary in the reinforced motorcycle frame. Thus, the reinforced motorcycle frame has high structural strength and is light and compact, which results in the motorcycle having half weigh comparing with the motorcycle equipped with a conventional motorcycle frame. Such that fuel can be saved whether the motorcycle is running or being transported by a vehicle.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a reinforced motorcycle frame in accordance with the present invention;

FIG. 2 is a side view of the reinforced motorcycle frame in FIG. 1; and

FIG. 3 is an operational perspective view of the reinforced motorcycle frame in FIG. 1 mounted in a motorcycle.

### DETAILED DESCRIPTION OF THE PREFERRED EMBODIMENT

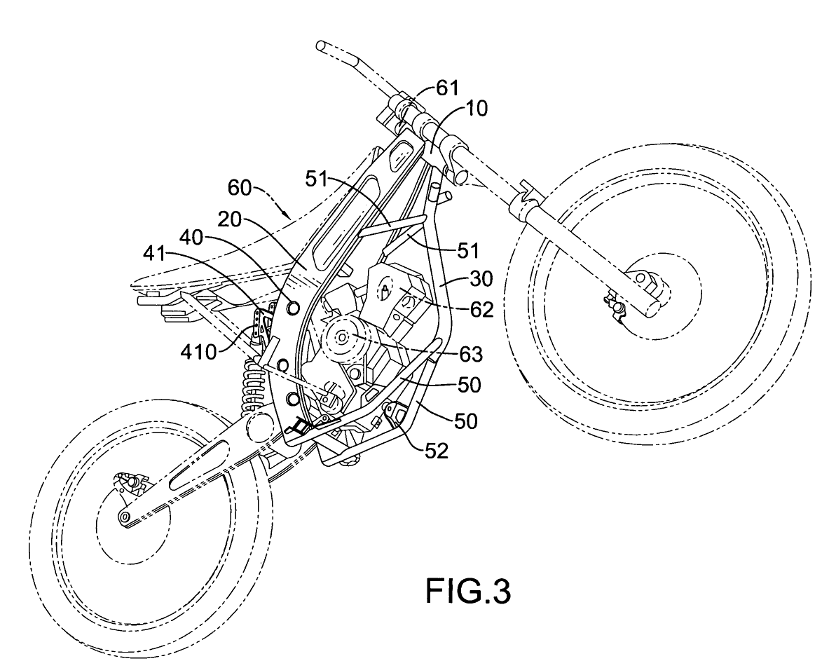

With reference to FIG. 3, a motorcycle (60) comprises a reinforced motorcycle frame in accordance with the present invention, a front fork (61), an engine (63) with a carburetor (62) and other associated parts, a front wheel assembly and a rear wheel assembly.

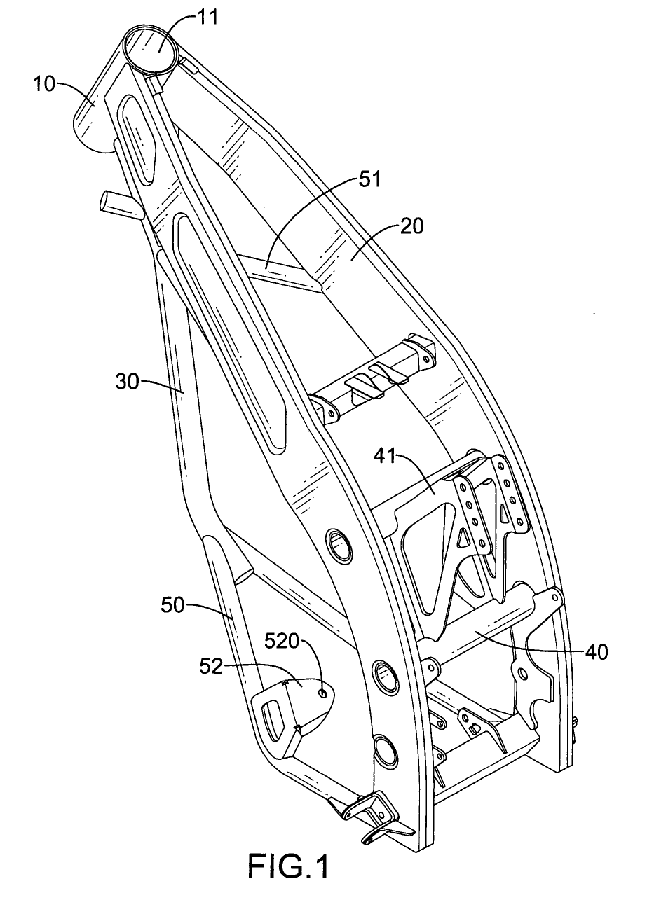

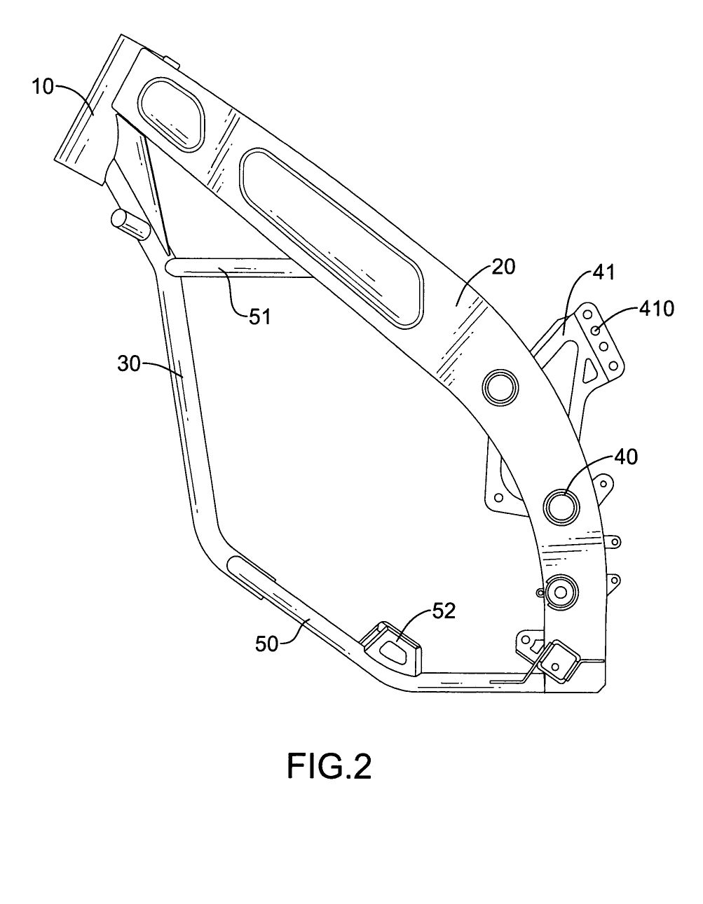

With further reference to FIGS. 1 and 2, the reinforced motorcycle frame comprises a head tube (10), at least two main beams (20), multiple transverse rods (40), at least one support beam (30), at least two mounting struts (50) and at least two reinforcing struts (51).

The head tube (10) has an outer surface and a central hole (11) through which the front fork (61) is rotatably mounted.

The main beams (20) form an inverted “V” shape and an interval, and each main beam (20) has an upper end and a lower end. The upper ends are attached securely to the outer surface of the head tube (10). The lower end is curved downwardly.

The transverse rods (40) are mounted between the main beams (20) parallel to each other at intervals, and each transverse rod (40) may be tubular and has two ends and at least one transverse rod (40) has an optional mounting bracket (41). The ends are attached respectively to the main beams (20). The mounting bracket (41) is used to attach other parts of the motorcycle (60) to the reinforced motorcycle frame and has multiple mounting holes (410).

The at least one support beam (30) is somewhat “S” shaped, and each support beam (30) has an upper end and a lower end. The upper end connects securely to the outer surface of the head tube (10) and the upper ends of the main beams (20), and extends downward in front of and between the main beams (20).

The mounting struts (50) connect the support beam (30) to the main beams (20) to form a mounting cavity in which motorcycle component can be mounted, and each mounting strut (50) has a front end, a rear end, and a bend and at least one mounting strut (50) has an optional motor mount (52). The front ends are connected securely to the lower end of the support beam (30). The rear ends are connected securely respectively to the lower ends of the main beams (20) to enhance overall structural strength of the reinforced motorcycle frame. The bend is formed between the front and rear ends to enlarge the mounting cavity so the engine (63), the carburetor (62) of the motorcycle (60) and other parts can be mounted in the mounting cavity. The motor mount (52) is attached securely to the mounting strut (50) adjacent to the bend and has multiple mounting holes (520) to attach the engine (63) to the reinforced motorcycle frame.

The reinforcing struts (51) are connected securely to the support beam (30) and respectively to the main beams (20), and each reinforcing strut (51) has a front end and a rear end. The front ends are attached securely to the support beam (30) near the upper end. The rear ends are attached respectively to the main beams (20) near upper ends to enhance overall structural strength of the reinforced motorcycle frame.

Even though numerous characteristics and advantages of the present invention have been set forth in the foregoing description together with details of the structure and function of the invention, the disclosure is illustrative only. Changes may be made in detail especially in matters of shape, size and arrangement of parts within the principles of the invention to the full extent indicated by the broad general meaning of the terms in which the appended claims are expressed.

What is claimed is:

1. A reinforced motorcycle frame comprising
at least two main beams forming an inverted “V” shape and an interval, and each main beam having
an upper end; and
an lower end;
at least one support beam having
an upper end connecting securely to the upper ends of the main beams and extending downward in front of and between the main beams; and
a lower end; and
multiple struts being connected between the support beam and the main beams to enhance overall structural strength of the reinforced motorcycle frame.

2. The reinforced motorcycle frame as claimed in claim 1 further has multiple transverse rods being mounted between the main beams parallel to each other at intervals, and each transverse rods having two ends attached respectively to the main beams.

3. The reinforced motorcycle frame as claimed in claim 2, wherein the struts includes
at least two mounting struts connecting the support beam to the main beams, and each mounting strut having
a front end being connected securely to the lower end of the support beam;
a rear end being connected securely respectively to the lower end of one of the main beams; and
at least two reinforcing struts being connected securely to the support beam and respectively to the main beams, and each reinforcing strut having
a front end being securely attached to the support beam near the upper end of the support beam; and
a rear end being attached respectively to one of the main beams near the upper end of the main beams.

4. The reinforced motorcycle frame as claimed in claim 3, wherein each mounting strut further has a bend being formed between the front and rear ends of the mounting strut.

5. The reinforced motorcycle frame as claimed in claim 3, wherein each transverse rod is tubular.

6. The reinforced motorcycle frame as claimed in claim 3, wherein
at least one transverse rod further has a mounting bracket having multiple mounting holes; and
at least one mounting strut further has a motor mount having multiple mounting holes.

7. The reinforced motorcycle frame as claimed in claim 3 further has a head tube having
an outer surface; and
a central hole; and
wherein the upper ends of the main beams are attached securely to the outer surface of the head tube.

8. The reinforced motorcycle frame as claimed in claim 3, wherein the lower end of each main beam is curved downwardly.
